(19) United States
(12) Patent Application Publication
(10) Pub. No.: US 2011/0072421 A1
(43) Pub. Date: Mar. 24, 2011

(54) METHOD, APPARATUS AND SYSTEM FOR UPDATING A SOFTWARE BUNDLE INSTALLED ON A MOBILE ELECTRONIC DEVICE

(75) Inventors: Thomas Owen PARRY, Waterloo (CA); Spencer Leavitt George Quin, Waterloo (CA); Timothy Richard Tyhurst, Waterloo (CA); Paul Edward Landry, Waterloo (CA)

(73) Assignee: RESEARCH IN MOTION LIMITED, Waterloo (CA)

(21) Appl. No.: 12/562,878

(22) Filed: Sep. 18, 2009

(51) Int. Cl. G06F 9/445

(52) U.S. Cl. 717/168

(57) ABSTRACT

A system, method and apparatus for updating a software bundle installed on a mobile electronic device via a computing device are provided. The computing device is enabled for communication with the mobile electronic device via a local connection, and further enabled for communication with at least one server storing software bundle data, via a communication network. Device configuration data is received, at the computing device, from the mobile electronic device via the local connection. At least a portion of the device configuration data is transmitted from the computing device to the at least one server. At least a portion is compared to the software bundle data to identify software modules for updating the software bundle. A first subset of the software modules to be added to the software bundle and a second subset of the software modules to be removed from the software bundle are determined. It is determined if installation data for adding the first subset to the software bundle is stored at the computing device and, if not, the installation data is requested from the at least one server via the communication network. The software bundle is updated by: causing the installation data to be installed on the mobile electronic device via the local connection once the installation data is received from the at least one server; and causing the second subset to be removed from the mobile electronic device.

### FIELD

The specification relates generally to mobile electronic devices, and specifically to a method, apparatus and system for updating a software bundle installed on a mobile electronic device.

### BACKGROUND

Installing software at a mobile electronic device, such as a PDA, is generally performed using over-the-air (OTA) protocols, which is wasteful of bandwidth in wireless communication networks where bandwidth can be costly. While some software can be installed via a local connection (e.g. a USB connection) at a computing device, generally the software must first be manually retrieved and stored at the computing device, which is wasteful of system resources at the computing device. Furthermore, such solutions do not allow for selective upgrades in a core bundle of software, such as installation and/or removal of language modules, etc. Rather, to effect such upgrades, the entire core bundle of software must be reinstalled, and the desired options (such as languages) chosen during reinstallation. This process is time consuming, and is a further waste of system resources.

### BRIEF DESCRIPTIONS OF THE DRAWINGS

Embodiments are described with reference to the following figures, in which:

FIG. 1 depicts a block diagram of a system for updating a software bundle installed on a mobile electronic device, according to non-limiting embodiments;

FIG. 2a depicts a schematic diagram of a software bundle to be updated, installed at a mobile electronic device, according to non-limiting embodiments;

FIG. 2b depicts a schematic diagram of a complete software bundle, stored at a server, according to non-limiting embodiments;

FIG. 2c depicts a schematic diagram of software bundle data, stored at a server, according to non-limiting embodiments;

FIG. 3 depicts a schematic diagram of device configuration data, according to non-limiting embodiments;

FIG. 4 depicts a block diagram of a method for updating a software bundle installed on a mobile electronic device, according to non-limiting embodiments;

FIG. 5 depicts a block diagram of a system for updating a software bundle installed on a mobile electronic device, according to non-limiting embodiments;

FIG. 6 depicts a block diagram of a method determining modules installed in a software bundle, according to non-limiting embodiments;

FIGS. 7 and 8 depict representations of a list of modules available for updating a software module, according to non-limiting embodiments;

FIG. 9 depicts a block diagram of a system for updating a software bundle installed on a mobile electronic device, according to non-limiting embodiments; and

FIG. 10 depicts a representation of a list of modules available for updating a software module, according to non-limiting embodiments.

### DETAILED DESCRIPTION OF THE EMBODIMENTS

A first aspect of the specification provides a method for updating a software bundle installed on a mobile electronic device, via a computing device enabled for communication with the mobile electronic device via a local connection, and further enabled for communication with at least one server storing software bundle data, via a communication network. The method comprises receiving device configuration data, at the computing device, from the mobile electronic device via the local connection. The method further comprises transmitting at least a portion of the device configuration data from the computing device to the at least one server via the communication network. The method further comprises comparing the at least a portion to the software bundle data to identify software modules for updating the software bundle. The method further comprises determining a first subset of the software modules to be added to the software bundle and a second subset of the software modules to be removed from the software bundle. The method further comprises determining if installation data for adding the first subset to the software bundle is stored at the computing device and, if not, requesting the installation data from the at least one server via the communication network. The method further comprises updating the software bundle by: causing the installation data to be installed on the mobile electronic device via the local connection once the installation data is received from the at least one server; and causing the second subset to be removed from the mobile electronic device.

The method can further comprise: determining a third subset of the software modules to be upgraded in the software bundle; requesting upgrade data for upgrading the third subset in the software bundle, from the at least one server via the communication network; and further updating the software bundle by causing the upgrade data to be installed on the mobile electronic device via the local connection once the upgrade data is received from the at least one server.

The method can further comprise receiving the software bundle data at the computing device such that the comparing occurs at the computing device.

The comparing can occur at the server, and the method can further comprise receiving, at the computing device, data identifying the software modules for updating, from the server.

Determining the first subset and the second subset can comprise: controlling a display device associated with the computing device to provide a representation of a list of the software modules for updating the software bundle; and, in response, receiving input data from an input device associated with the computing device, the input data indicative of the first subset and the second subset, each respectively chosen from the list.

The device configuration data can comprise at least an identifier for identifying the software bundle, a carrier identifier for identifying a carrier network operator, a list of installed application modules associated with the software bundle and a list of installed language modules associated with the software module.

The software modules for updating the software bundle can comprise at least one of application modules and language modules for installation in the software bundle.

The local connection can comprise at least one of a wired connection, a wireless connection, a cabled connection, a USB connection, a WiFi connection, a Bluetooth connection, and a near field communication (NFC) connection.

The at least a portion can be transmitted to a first server for storing the software bundle data and the installation data can be requested from a second server for storing the installation data.

A second aspect of the specification provides a computing device for updating a software bundle installed on a mobile electronic device. The computing device comprises a processing unit interconnected with a memory device and a communication interface enabled for communication with the mobile electronic device via a local connection. The communication interface is further enabled for communication with at least one server storing software bundle data via a communication network. The processing unit is enabled to receive device configuration data from the mobile electronic device via the local connection. The processing unit is further enabled to transmit at least a portion of the device configuration data to the at least one server via the communication network such that the at least a portion is compared to the software bundle data to identify software modules for updating the software bundle. The processing unit is further enabled to determine a first subset of the software modules to be added to the software bundle and a second subset of the software modules to be removed from the software bundle. The processing unit is further enabled to determine if installation data for adding the first subset to the software bundle is stored at the memory device and, if not, request the installation data from the at least one server via the communication network. The processing unit is further enabled to update the software bundle by: causing the installation data to be installed on the mobile electronic device via the local connection once the installation data is received from the at least one server; and causing the second subset to be removed from the mobile electronic device.

The processing unit can be further enabled to: determine a third subset of the software modules to be upgraded in the software bundle; request upgrade data for upgrading the third subset in the software bundle, from the at least one server via the communication network; and further update the software bundle by causing the upgrade data to be installed on the mobile electronic device via the local connection once the upgrade data is received from the at least one server.

The processing unit can be further enabled to receive the software bundle data at the computing device such that the at least a portion is compared to the software bundle data occurs at the computing device.

The at least a portion can be compared to the software bundle data at the server and the processing unit can be further enabled to receive data identifying the software modules for updating, from the server.

The processing unit can be further enabled to determine the first subset and the second subset by: controlling a display device associated with the computing device to provide a representation of a list of the software modules for updating the software bundle; and, in response, receiving input data from an input device associated with the computing device, the input data indicative of the first subset and the second subset, each respectively chosen from the list.

The device configuration data can comprise at least an identifier for identifying the software bundle, a carrier identifier for identifying a carrier network operator, a list of installed application modules associated with the software bundle and a list of installed language modules associated with the software module.

The software modules for updating the software bundle can comprise at least one of application modules and language modules for installation in the software bundle.

The local connection can comprise at least one of a wired connection, a wireless connection, a cabled connection, a USB connection, a WiFi connection, a Bluetooth connection, and a near field communication (NFC) connection.

The at least a portion can be transmitted to a first server for storing the software bundle data and the installation data can be requested from a second server for storing the installation data.

A third aspect of the specification provides a system for updating a software bundle. The system comprises a mobile electronic device, the software bundle installed thereon. The system further comprises at least one server storing software bundle data. The system further comprises a computing device enabled for communication with the mobile electronic device via a local connection, and further enabled for communication with at least one server storing software bundle data, via a communication network. The computing device is enabled to receive device configuration data from the mobile electronic device via the local connection. The computing device is further enabled to transmit at least a portion of the device configuration data to the at least one server via the communication network such that the at least a portion is compared to the software bundle data to identify software modules for updating the software bundle. The computing device is further enabled to determine a first subset of the software modules to be added to the software bundle and a second subset of the software modules to be removed from the software bundle. The computing device is further enabled to determine if installation data for adding the first subset to the software bundle is stored at the computing device and, if not, request the installation data from the at least one server via the communication network. The computing device is further enabled to update the software bundle by: causing the installation data to be installed on the mobile electronic device via the local connection once the installation data is received from the at least one server; and causing the second subset to be removed from the mobile electronic device.

A fourth aspect of the specification provides a computer program product, comprising a computer usable medium having a computer readable program code adapted to be executed to implement a method for updating a software bundle installed on a mobile electronic device, via a computing device enabled for communication with the mobile electronic device via a local connection, and further enabled for communication with at least one server storing software bundle data, via a communication network. The method comprises: receiving device configuration data, at the computing device, from the mobile electronic device via the local connection; transmitting at least a portion of the device configuration data from the computing device to the at least one server via the communication network; comparing the at least a portion to the software bundle data to identify software modules for updating the software bundle; determining a first subset of the software modules to be added to the software bundle and a second subset of the software modules to be removed from the software bundle; determining if installation data for adding the first subset to the software bundle is stored at the computing device and, if not, requesting the installation data from the at least one server via the communication network; and updating the software bundle by: causing the installation data to be installed on the mobile electronic device via the local connection once the installation data is received from the at least one server; and causing the second subset to be removed from the mobile electronic device.

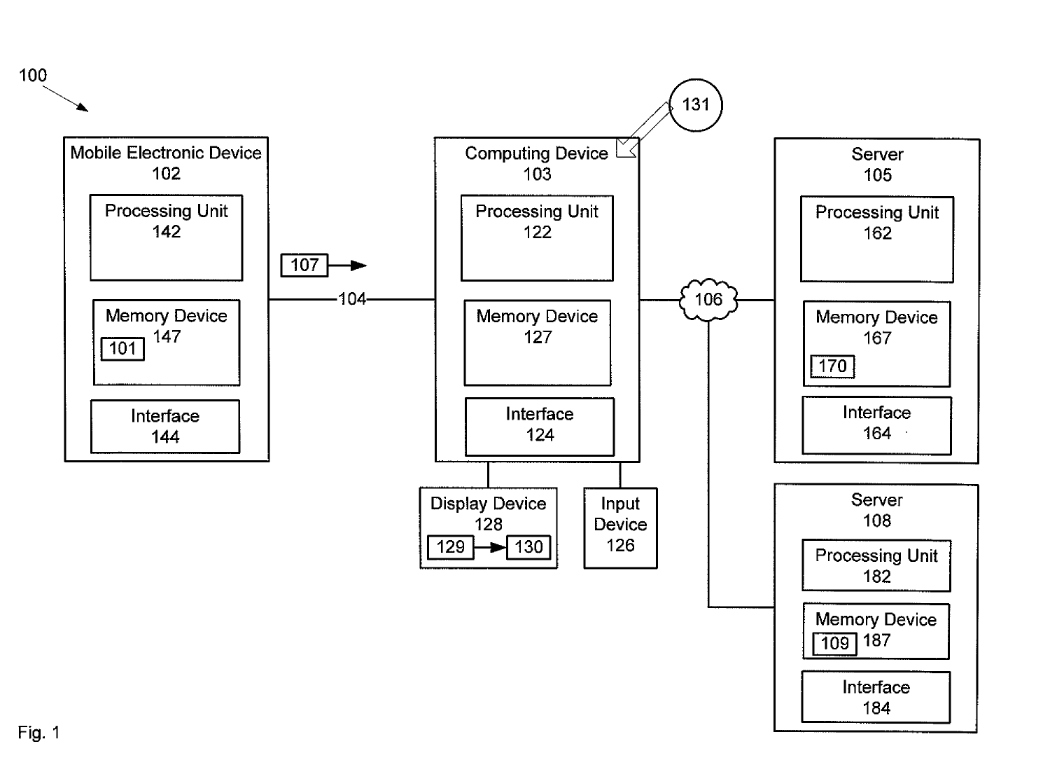

FIG. 1 depicts a system 100 for updating a software bundle 101 installed on a mobile electronic device 102 via a computing device 103, according to non-limiting embodiments. Computing device 103 is enabled for communication with mobile electronic device 102 via a local connection 104. Computing device 103 is further enabled for communication with at least one server 105 via a communication network 106. At least one server 105 stores software bundle data 170 comprising data identifying software modules associated with software bundle 101. In general, computing device 103 is further enabled to facilitate updating software bundle 101 by: receiving device configuration data 107 from mobile electronic device 102; and identifying software modules for updating software bundle 101, via communication with server 105, as described below. In some embodiments, system 100 further comprises a server 108, computing device 103 further enabled for communication with server 108 via communication network 106. Server 108 is generally enabled to store complete software bundle data 109, described below. However, in other embodiments, complete software bundle 109 can be stored at server 105.

It is understood that local connection 104 can comprise any suitable combination of wired and wireless links desired, such that computing device 103 can communicate with mobile electronic device 102 when mobile electronic device 102 is local to computing device 103. Local connection 104 can include, but is not limited to a wired connection, a wireless connection, a cabled connection, a USB connection, a WiFi connection, a Bluetooth connection, a near field communication (NFC) connection, and the like or a combination. Other suitable local connections are within the scope of present embodiments. In particular, local connection 104 excludes connections with wireless networks over which mobile electronic device 102 can communicate with remote communication devices, for example wireless networks operated by a carrier network operator.

Communication network 106 can comprise any suitable combination of wired or wireless networks as desired, including but not limited to a packet based network, the Internet, an analog network, the PSTN, a WiFi network, a WiMax network and the like.

Computing device 103 comprises a processing unit 122 interconnected with a communication interface 124 and a memory device 127, for example via a computing bus (not depicted). Computing device 103 is further associated with an input device 126 and a display device 128 in communication with computing device 103, such that input data can be received at processing unit 122 from input device 126, and display device 128 can be controlled by processing unit 122. As depicted, input device 126 and display device 128 are external to computing device 103, however in other embodiments, computing device 103 can comprise input device 126 and display device 128. Computing device 103 further comprises an application 131 that can be stored in memory device 127 and processed by processing unit 122. Application 131 generally comprises an application for updating software bundle 101, and is described in further detail below.

In general, computing device 103 comprises any suitable computing device for processing application 131 and communicating with mobile electronic device 102 and server 105, including but not limited to any suitable combination of personal computers and laptop computing devices. Other suitable computing devices are within the scope of present embodiments.

Processing unit 122 comprises any suitable processor, or combination of processors, including but not limited to a microprocessor, a central processing unit (CPU) and the like. Other suitable processing units are within the scope of present embodiments.

Communication interface 124 comprises any suitable communication interface, or combination of communication interfaces, enabled to communicate with mobile electronic device 102 via local connection 104 and with server 105 (and server 108, if present) via communication network 106. Accordingly, communication interface 124 is enabled to communicate via local connection 104 according to any suitable protocol which is compatible with local connection 104, including but not limited to wired protocols, USB protocols, serial cable protocols, wireless protocols, Bluetooth protocols, NFC protocols and/or a combination, or the like. Furthermore, communication interface 124 is enabled to communicate via communication network 106 according to any suitable protocol which is compatible with communication network 106, including but not limited to packet based protocols, Internet protocols, analog protocols, PSTN protocols, WiFi protocols, WiMax protocols and the like, and/or a combination. Further, communication interface 124 is enabled to communicate in a wireless or wired manner, as desired. Other suitable communication interfaces and/or protocols are within the scope of present embodiments.

Input device 126 is generally enabled to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present embodiments.

Memory device 127 can comprise any suitable memory device, including but not limited to any suitable one of or combination of volatile memory, non-volatile memory, random access memory (RAM), read-only memory (ROM), hard drive, optical drive, flash memory, magnetic computer storage devices (e.g. hard disks, floppy disks, and magnetic tape), optical discs, and the like. Other suitable memory devices are within the scope of present embodiments. Other suitable memory devices are within the scope of present embodiments. In particular, memory device 127 is enabled to store representation data for controlling display device 128 to display a representation 129 of data, for example a representation of application 131.

Display device 128 comprises circuitry 129 for generating representation 130. Display device 128 can include any suitable one of or combination of CRT and/or flat panel displays (e.g. LCD, plasma, AMOLED, capacitive or resistive touchscreens, and the like). Circuitry 129 can include any suitable combination of circuitry for controlling the CRT and/or flat panel displays etc., including but not limited to display buffers, transistors, electron beam controllers, LCD cells, plasmas cells, phosphors etc. In particular, display device 128 and circuitry 129 can be controlled by processing unit 122 to generate representation 130.

Mobile electronic device 102 can comprise one or a combination of a PDA, a cell phone, a mobile phone, a mobile communication device, and a portable electronic device. Mobile electronic device 102 comprises a processing unit 142, a communication interface 144, and a memory device 147, all in communication, for example, via a computing bus (not depicted). Each of processing unit 142, communication interface 144, and memory device 147 can be respectively similar to processing unit 122, communication interface 124, and memory device 147, described above. In particular, it is understood that communication interface 144 is enabled to communicate with computing device 103 via local connection 104 via any suitable combination of wired and wireless protocols, similar to communication interface 124. It is further understood that, in some embodiments, communication interface 144 can be enabled to communicate with remote communication device via at least a wireless network (not depicted), for example a wireless network operated by a carrier network operator.

It is understood that mobile electronic device 102 generally comprises software bundle 101 stored in memory device 147, software bundle 101 processable by processing unit 142 to enable various applications and functionality of mobile electronic device 102. It is understood that software bundle 101 was previously installed on mobile electronic device 102 in a provisioning process, for example at a factory and/or when mobile electronic device 102 is first activated.

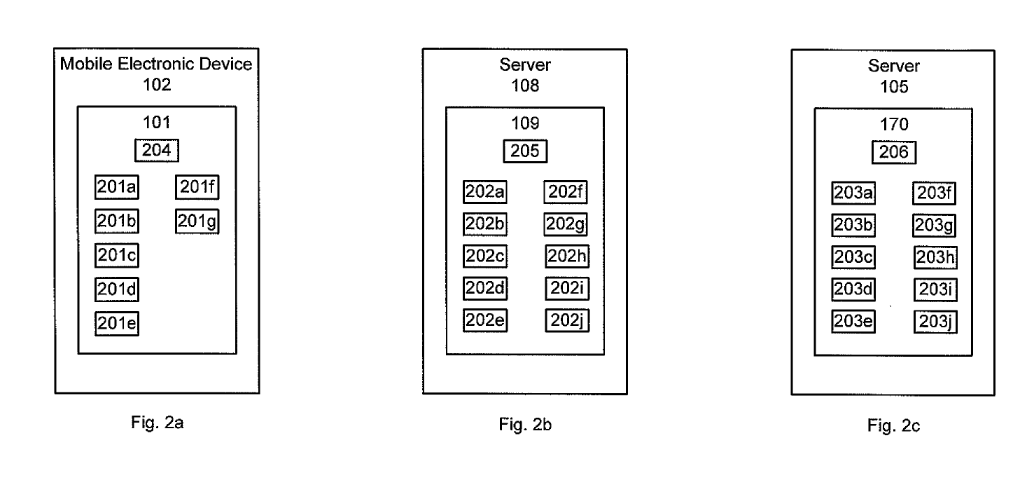

It is understood that software bundle 101 is associated with a plurality of software modules, only a portion of which are installed in the provisioning process. For example, attention is directed to FIG. 2a, which depicts a schematic of mobile electronic device 102 including software bundle 101, according to non-limiting embodiments. It is understood that while FIG. 2a depicts only software bundle 101 at mobile electronic device 102, other elements of mobile electronic device 102 are nonetheless present in mobile electronic device 102, for example elements depicted in FIG. 1. In any event, software bundle 101 comprises a plurality of software modules 201a to 201g (collectively, modules 201 and generically a module 201), which can be stored in any suitable manner in memory device 147. Each software module 201 comprises at least one of an operating system module, an applications module, a language module, or any other suitable software module. While only seven software modules 201 are depicted in present embodiments, it is understood that software bundle 101 can comprise any suitable number of modules 201. Furthermore, it is understood that each module 201 can comprise any suitable number of files, and that various modules 201 can share files and resources: in other words, while each module 201 is depicted as a distinct element in FIG. 2a, each module 201 can comprise any suitable data structure for implementing each module 201 at mobile electronic device 102.

In some embodiments, software bundle 101 comprises a core bundle of software modules for operating mobile electronic device 102 including, but not limited to operating system modules, applications modules, language modules, and the like.

Furthermore, software bundle 101 can comprise an identifier 204 identifying software bundle 101; for example identifier 204 can comprise a name and/or a version number of software bundle 101, and can be any suitable combination of alphanumeric characters. In other embodiments, software bundle 101 does not comprise identifier 204; rather, software bundle 101 is stored in association with identifier 204.

In further embodiments, more than one software bundle is installed on mobile electronic device 102, with modules of each respective software module identified via an identifier similar to identifier 204. It is understood that each software bundle can comprise at least one software module, similar to software bundle 101.

Furthermore, it is understood that while only seven modules 201 are installed on mobile electronic device 102, software bundle 101 can be associated with any number of modules that can be installed on mobile electronic device 102. For example, as depicted in FIG. 2b, server 108 stores complete software bundle 109, which comprises a plurality of software installation modules 202a to 201j (collectively, modules 202 and generically a module 202), which can be stored in any suitable manner at server 108, as described below. Each module 202 comprises respective installation data for updating software bundle 101. It is understood that while FIG. 2b depicts only complete software bundle 109 at server 108, other elements of server 108 are nonetheless present in server 108, for example elements depicted in FIG. 1, and described below. Each module 202 comprises data for installing a corresponding module 201 on mobile electronic device 102. Modules 202a to 202g correspond respectively to modules 201a to 201g, while modules 202h to 202j correspond to modules which can be installed on mobile electronic device 102 to update software bundle 101.

In a non-limiting example, module 201a installed on mobile electronic device 102 can comprise an English language module installed on mobile electronic device 102 in the provisioning process; furthermore, modules 202h to 202j can correspond to other language modules available for installation (e.g. German, French, Mandarin, and the like). While the non-limiting example is directed to installation of additional language modules, in other embodiments additional applications can be available for installation on mobile electronic device 102. Furthermore, while only ten modules 202 are depicted in present embodiments, it is understood that complete software bundle 109 can comprise any suitable number of modules 202.

In general, it is hence desirable to update software bundle 101 to install at least one further module 202 and/or replace a module 201 (e.g. to install further language modules and/or replace a current language module). In particular, it is desirable to update software module 201 without making use of a carrier operator network. Furthermore, in the prior art, once a core bundle of software is installed on a mobile electronic device the core bundle cannot be updated without reinstallation of an entire updated core bundle of software with various options chosen at the time of reinstallation (e.g. with reference to FIG. 2b, upon reinstallation, modules 202b through 202h can be installed with the net result of a German language module (e.g. module 202h) replacing an English language module (e.g. module 201a)).

In some embodiments, complete software bundle 109 can further comprise an identifier 205, which is substantially the same as identifier 204. For example, though not depicted, server 108 can store a plurality of different complete software bundles, similar to complete software bundle 109, but for different devices and/or for different operating systems. Hence given identifier 204 associated with software bundle 101, the corresponding complete software bundle 109 can be identified by comparing identifier 204 with identifiers of complete software bundles stored at server 108; when a substantial match is found between identifier 204 and identifier 205, it is understood that complete software bundle 109 corresponds to software bundle 101. In some embodiments, identifier 205 can be stored in a database (not depicted) at server 108, in association with a pointer to complete software bundle 109. In other embodiments, identifier 205 (and/or complete software bundle 109) can be stored in a local cache of server 108. While a local cache is not depicted, in some embodiments, memory device 187 can comprise a local cache of server 108. Hence, in some of these embodiments, complete software bundle 109 does not comprise identifier 205; rather, complete software bundle 109 is stored in association with identifier 205.

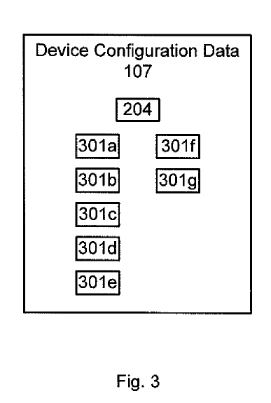

Returning to FIG. 1, mobile electronic device 102 is further enabled to determine device configuration data 107, for example by processing software bundle 101 and/or determining and storing device configuration data 107 when software bundle 101 is installed. In general device configuration data 107 comprises data for determining a state of software bundle 101. For example, as depicted in FIG. 3, device configuration data 107 can include, but is not limited to, identifier 204 for identifying software bundle 101. Device configuration data 107 can further include, but is not limited to respective identifiers 301a-301g (collectively identifiers 201, and generically identifiers 201) of installed modules 201a-201g. In general, identifiers 301a-301g are substantially similar to identifiers 203a-203g stored at server 105, such that a comparison of an identifier 301 with a respective identifier 203 results in a match. In some embodiments, software bundle 101 can further comprise identifiers 301, for example stored in software bundle 101 in a provisioning process at installation. In other embodiments, each identifier 301 can be determined by processing modules 201. In some embodiments, device configuration data 107 can comprise a carrier identifier for identifying a carrier network operator.

Returning to FIG. 1, server 105 comprises a processing unit 162, a communication interface 164, and a memory device 167, all in communication, for example, via a computing bus (not depicted). Each of processing unit 162, communication interface 164, and memory device 167 can be respectively similar to processing unit 122, communication interface 124, and memory device 127, described above. It is understood that communication interface 164 is further enabled to communicate with computing device 103 via communication network 106 via any suitable combination of wired and wireless protocols, similar to communication interface 184.

Server 105 further comprises software bundle data 170 which comprises data for identifying modules associated with software bundle 101, including modules 201 and/or modules 202 available for installation on mobile electronic device 102. For example, attention is directed to FIG. 2c, which depicts a schematic of server 105 including software bundle data 170, according to non-limiting embodiments. It is understood that while FIG. 2b depicts only software bundle data 170 at server 105, other elements of server 105 are nonetheless present in server 105, for example elements depicted in FIG. 1. In any event, software bundle data 170 comprises a plurality of identifiers 203a to 203j (collectively, identifiers 203 and generically an identifier 203), which can be stored in any suitable manner in memory device 167. Each identifier 203 comprises an identifier of a respective module 201 and/or a corresponding installation modules 202 associated with software bundle 101. For example, a single identifier 203a can be used to identify both module 201a and corresponding module 202a.

In some embodiments, software bundle data 170 can further comprise an identifier 206, which is substantially the same as identifier 204. For example, though not depicted, server 105 can store a plurality of different software bundle data, similar to software bundle data 170, but for different devices and/or for different operating systems. Hence, given identifier 204 associated with software bundle 101, the corresponding software bundle data 170 can be identified by comparing identifier 204 with identifiers of software bundle data stored at server 105; when a substantial match is found between identifier 204 and identifier 206, it is understood that software bundle data 170 corresponds to software bundle 101. In some embodiments, identifier 206 can be stored in a database (not depicted) at server 105, in association with a pointer to software bundle data 170. In other embodiments, identifier 206 (and/or software bundle data 170) can be stored in a local cache of server 105. While a local cache is not depicted, in some embodiments, memory device 167 can comprise a local cache of server 105. Hence, in some of these embodiments, software bundle data 170 does not comprise identifier 205; rather, software bundle data 170 is stored in association with identifier 206.

Returning to FIG. 1, server 108 comprises a processing unit 182, a communication interface 184, and a memory device 187, all in communication, for example, via a computing bus (not depicted). Each of processing unit 182, communication interface 184, and memory device 187 can be respectively similar to processing unit 122, communication interface 124, and memory device 127, described above. It is understood that communication interface 184 is further enabled to communicate with computing device 103 via communication network 108 via any suitable combination of wired and wireless protocols, similar to communication interface 184. Furthermore, memory device 187 is enabled to store complete software bundle 109, described above.

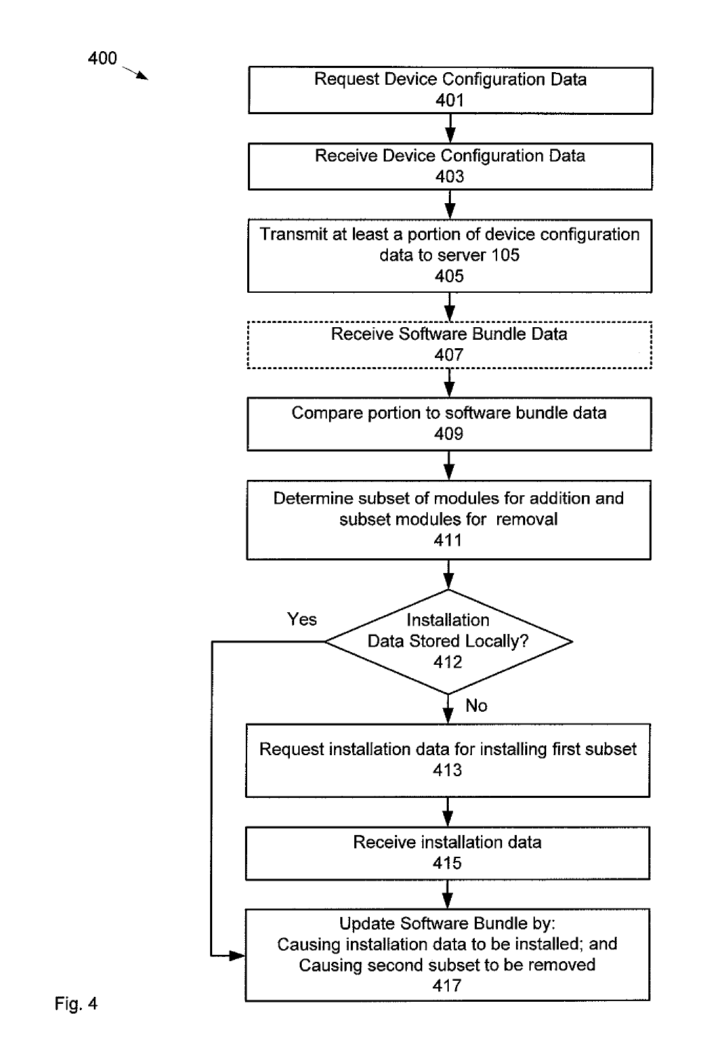

Attention is now directed to FIG. 4 which depicts a method 400 for updating a software bundle installed on a mobile electronic device. In order to assist in the explanation of method 400, it will be assumed that method 400 is performed using system 100. Furthermore, the following discussion of method 400 will lead to a further understanding of system 100 and its various components. However, it is to be understood that system 100 and/or method 400 can be varied, and need not work exactly as discussed herein in conjunction with each other, and that such variations are within the scope of present embodiments.

In method 400, is it assumed that mobile electronic device 102 has been connected to computing device 103 via local connection 104, and that communications have been established there between. It is further understood that method 400 can occur when application 131 is processed at processing unit 122.

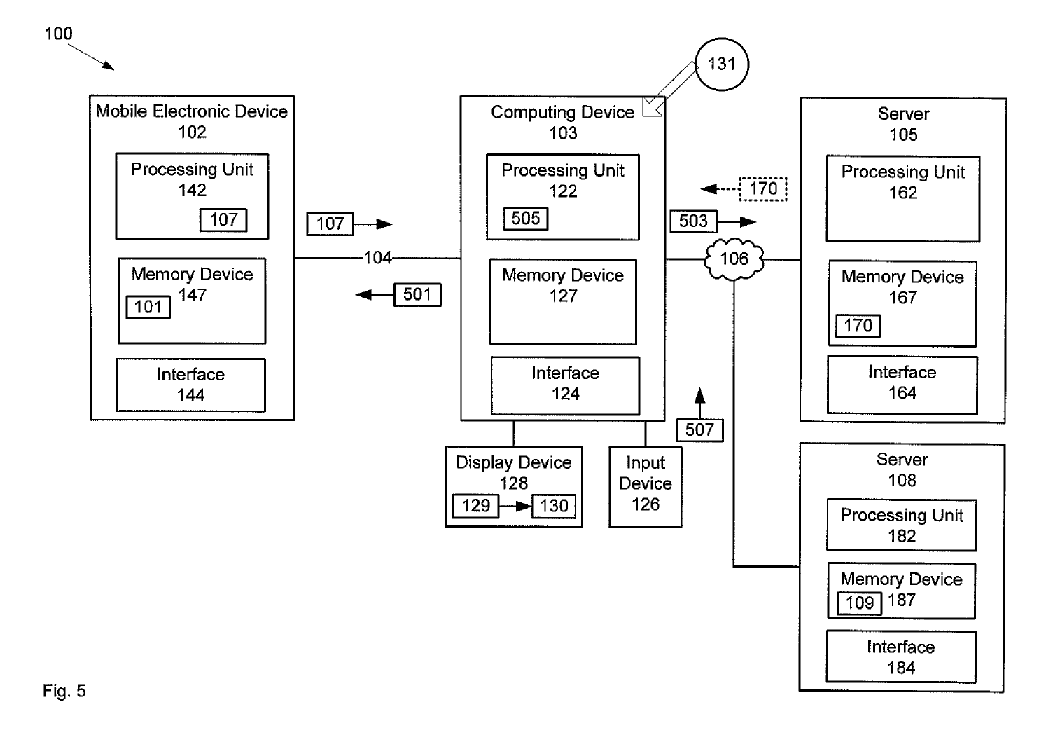

At step 401, computing device 103 can request device configuration data 107 from mobile electronic device 102, via a request 501 transmitted via local connection 104, as depicted in FIG. 5 (which is substantially similar to FIG. 1 with like elements having like numbers). When request 501 is received at mobile electronic device 102, mobile electronic device 102 responds by generating (if necessary) and transmitting device configuration data 107 to computing device 103 via local connection 104.

In some embodiments, when request 501 is received at mobile electronic device 102, mobile electronic device 102 determines device configuration data 107 by processing software bundle 101 at processing unit 142. In other embodiments, device configuration data 107 can be stored in memory device 147 (e.g. device configuration data 107 is determined and stored when software bundle 101 is first installed and/or updated); in these embodiments, processing unit 142 causes device configuration data 107 to be retrieved from memory 147 and transmitted to computing device 103 via local connection 104.

In some embodiments, step 401 can be triggered via receipt of input data at computing device 103, via input device 126, which indicates that an update of software bundle 101 is to occur. In other embodiments, step 401 can be triggered once local connection 104 has been established. In yet further embodiments, step 401 can be triggered when application 131 is processed at computing device 103.

In other embodiments, step 401 is optional, and mobile electronic device 102 transmits device configuration data 107 to computing device 103 when it is determined that local connection 104 has been established, or while local connection 104 is being established (e.g. device configuration data 107 is transmitted to computing device 103 in a hand-shaking process while local connection 104 is being established).

In any event, at step 403, device configuration data 107 is received at computing device 103 via local connection 104. As described above, device configuration data 107 comprises data for determining a state of software bundle 101.

At step 405, at least a portion 503 of device configuration data 401 is transmitted from computing device 103 to server 105 via communication network 403. In some embodiments, portion 503 comprises a subset of device configuration data 107, for example data which enables server 105 to determine which software bundle 101 is installed at mobile electronic device 102, such as identifier 204. In some of these embodiments, portion 503 can further comprise data which enabled server 105 to determine which modules 201 are installed in software bundle 101, such as identifiers 301. In other embodiments, portion 503 can comprise a substantial portion of device configuration data 107, for example both identifier 204 and identifier 201.

In any event, once portion 503 is received at server 105, portion 503 is processed by processing unit 162 to identify software bundle data 170 (e.g. from a plurality of software bundle data), for example via a comparison of identifier 204 with identifier 206.

In some embodiments, at an alternate step 407, software bundle data 170 is received at computing device 103 as, in these embodiments, when server 105 identifies software bundle data 170, server 105 transmits software bundle data 170 to computing device 103 via communication network 106.

In any event, at step 409, portion 503 is compared to software bundle data 170 to identify software modules for updating software bundle 101. In embodiments where step 407 occurs, the comparison of step 409 can occur at computing device 103. In embodiments where portion 503 comprises respective identifiers of modules 201, the comparison of step 409 can occur at server 105.

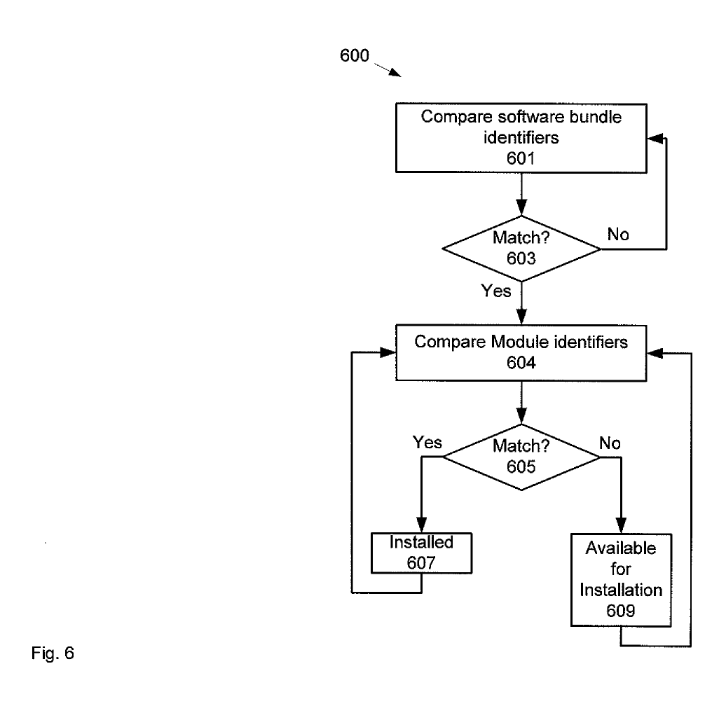

In any event, a non-limiting example the comparison of step 409 is provided within a method 600, as depicted in FIG. 6, according to non-limiting embodiments. At step 601 and step 603, occurring at server 105, identifier 204 is compared (step 601) with identifiers of software bundle data stored at server 105, including software bundle data 170 until a match is found (step 603), e.g. identifier 204 is found to match identifier 206. In embodiments where it is understood that software bundle data 170 is the only software bundle data stored at server 105, steps 601 and 603 can be optional, or can be used simply to verify that identifier 204 matches identifier 206.

In any event, once a match is found, at step 604 each identifier 301 is, in turn, compared to identifiers 203, or vice versa. When a match is found (step 605), it is determined at step 607 that a module 202 associated with a given identifier 301 (or identifier 201, as respective identifiers 203 and 301 are substantially the same) is installed in software bundle 101. If a match is not found, it is determined at step 607 that a module 202 associated with a given identifier 203 (or the corresponding identifier 301, as respective identifiers 203 and 301 are substantially the same) is available for installation in software bundle 101. The comparison of step 604 then continues until all identifiers 203 are classified as either installed, or available for installation, in software bundle 101, and data 505 indicative of the classification of each identifier 203 is determined, data 505 depicted in FIG. 5.

It is understood that steps 604 through 609 can occur at server 105 or at computing device 103. If at computing device 103, then it is understood that when a match is found at step 603, server 105 transmits at least identifiers 203 to computing device 103 for determination of data 505. If at server 105, then it is understood that server 105 then determines data 505 and then transmits data 505 to computing device 103. In some embodiments, data 505 can further comprise possible add/remove options associated with each identifier 203, and hence associated with a respective module 201 and a respective module 202.

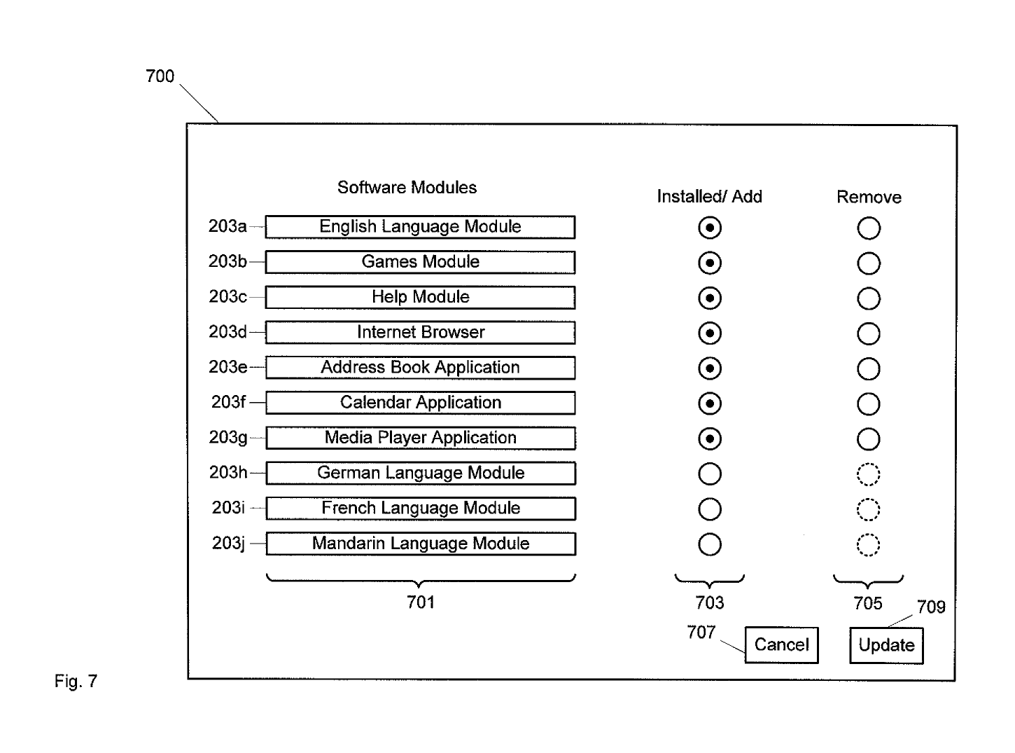

In any event, returning to FIG. 4, at step 411 a first subset of modules 202 to be added to software bundle 101 and a second subset of the modules 201 to be removed from software bundle 101 are determined. In some embodiments, the determination of the first and second subsets can occur via representation 700 depicted in FIG. 7. For example, processing unit 122 can control display device 128 to provide representation 700, of a list 701 of modules 201 for updating software bundle 101, representation 700 depicted in FIG. 7 described below; and, in response, receiving input data 507 from input device 126, input data 507 indicative of the first subset and the second subset, each respectively chosen from list 701.

As depicted in FIG. 7, according to non-limiting embodiments, representation 700 comprises list 701 of modules 202 for updating software bundle 101, each item in list 701 corresponding to a respective module 202 identified by respective identifier 203, which in these embodiments are alpha-numeric identifiers (e.g. “English Language Module”). Representation 130 can comprise representation 700. Respective indicators 703 are provided adjacent each item in list 701, indicative of whether each respective module 202 (e.g. a respective module 201) is already installed or available to be installed/added. For example a respective indicator 701 adjacent “English Language Module” is “on” (i.e. filled in), indicative that the respective module 201a is already installed; similarly, a respective indicator 701 adjacent “German Language Module” is “off” (i.e. filled not in), indicative that the respective module 201h is not installed, but available to be installed/added. Respective indicators 705 are also provided adjacent each item in list 701, for indicating whether a respective module 201 already installed is to be removed. Furthermore, in some embodiments, the add/remove options available via indicators 703 and indicators 705 can be provided in accordance with add/remove options associated with each identifier 203, and provided in data 505, described above.

For example a respective indicator 705 adjacent “English Language Module” is “off” (i.e. not filled in), indicative that the respective module 201a is can be removed if the respective indicator 705 is selected; similarly, no respective indicator 701 is adjacent “German Language Module”, indicative that the respective module 201a is not installed (in some embodiments, as depicted, an outline of a respective indicator can be provided).

In some embodiments, the add/remove options represented by indicators 703, 705 can be provided according to data 505.

In depicted non-limiting exemplary embodiments, indicators 703, 705 comprise radio buttons, however any suitable indicator is within the scope of present embodiments. It is understood that each radio button can be turned “on” or “off” upon receipt of input data 507. It is further understood that, in some embodiments, given a pair of respective indicators 703, 705 only one can be “on” at a given time; hence if a respective indicator 705 is selected, then the indicator 703 in the pair is controlled to be “off”.

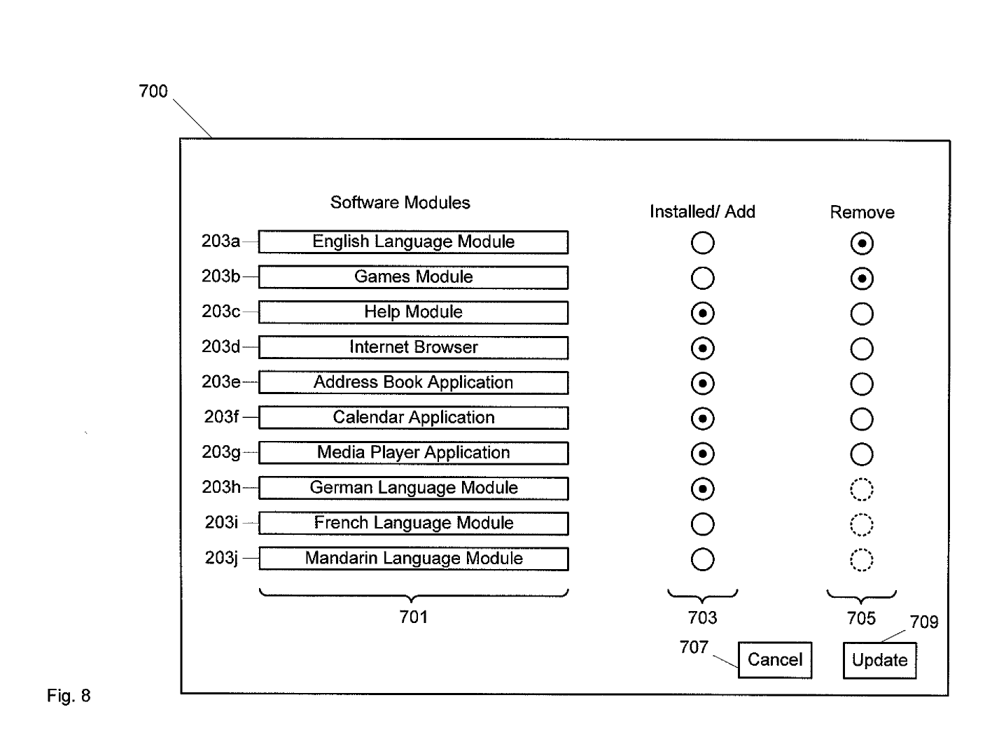

In any event, input data 507 is indicative of a selection of a module 202 for installation (corresponding to a selected indicator 703) and/or a selection of a module 201 for removal (corresponding to a selected indicator 705). In non-limiting exemplary embodiment, after processing of input data 507, display device 128 is controlled to update representation 700 as depicted in FIG. 8. From FIG. 8 it is understood that module 201a (“English Language Module”), corresponding to module 202a, and module 201b (“Games Module”), corresponding to module 202b, are to be removed, and module 202h (“German Language Module”) is to be installed. Hence it is determined that the first subset of modules 202 to be added to software bundle 101 comprises module 202h, and the second subset of the modules 201 to be removed from software bundle 101 comprises modules 201a, 201b.

While, in exemplary embodiments the first set comprises one module 201 and the second set comprises two modules 202, in other embodiments, first set and second set can comprise any suitable number of respective modules 201, 202.

Furthermore, in some embodiments, it is understood that if a given first module 202 is in the second set, then a given second module 201 must be in the second set. For example, in some of these embodiments, mobile electronic device 102 can be enabled to process one language module. Hence if a German language module is to be installed/added (e.g. module 202h) then an installed English language module must be removed (e.g. module 201a). In other embodiments, the reverse must be true: for example if an installed language module (e.g. module 201a) is to be removed, then at least one other language module (e.g. at least one of modules 202h, 202i, 202j) must be selected for installation. In some of these embodiments, a default choice can be implemented by processing unit 122 (e.g. the next language module in list 701).

In these embodiments, such add/remove options can be stored in software bundle data 170, and/or specified in data 505. Such add/remove options can be processed by processing unit 122 to control display device 128 when representation 700 is provided/updated. For example, if indicator 703 associated with “German Language Module” is chosen, the respective indicator 703 associated with “English Language Module” is automatically turned “off”, and the respective indicator 705 associated with “English Language Module” is automatically turned “on”. However, it is understood that controlling a number of language modules that can be installed on mobile electronic device 102 is provided only as a non-limiting example and that in other embodiments, there is no restriction on the number of language modules that can simultaneously be present on mobile electronic device 102.

In any event, other such logic for controlling representation 700, and defining the first set and the second set, can be indicated in software bundle data 170 and/or data 505, and processed by processing unit 122. For example, it is further understood that there are embodiments comprising dependencies between installation options for modules 201, 202 and that dependencies can exist between modules 201, 202, regardless of wherther modules 201, 202 are language modules, application modules etc. For example, in some embodiments, dependencies exist between modules 201, 203 which specify what certain modules 202 are to be installed if certain other modules 202 are already slated for installation. Furthermore, such dependencies can affect the indicators 703, 705 in representation 700: for example, if addition of a module identified by identifier 203g depends on the module identified by identifier 203f being installed on mobile electronic device 102, then the module identified by identifier 203f cannot be selected for removal unless the module identified by identifier 203g is either not installed, or is selected for removal as well via indicators 703, 705.

Representation 700 further comprises virtual buttons 707, labelled “Cancel”, and 709, labelled “Update”. If input data indicative that button 707 has been activated is received at processing module 122, then method 400 can be terminated and software bundle 101 is not upgraded. On the other hand, if input data indicative that button 709 has been activated is received at processing module 122, then method 400 processing module 122 proceeds with updating software bundle 709 at step 413, described below.

In other embodiments, a determination of the first subset and second subset can occur automatically. For example, it may have been determined that a given module 301 installed in software bundle 101 is unstable/unreliable and an administrative decision can be made to replace the given module 301 with a new module 202. Complete software data 170 can reflect this requirement via logic stored in complete software data 170, and hence when step 409 occurs, such logic can be processed by the appropriate processing unit 122, 162, such that first and second sets are determined automatically at step 411. In some of these embodiments, processing unit 122 controls display device 128 to provide representation 700, however the appropriate indicators 703, 705 are automatically controlled to reflect the logic stored in complete software data 170 such that the logic cannot be overridden, For example, the appropriate indicators 703, 705 can be disabled, while other indicators 703, 705 can still be activated/inactivated such that further modules 201, 202 can be added/removed from each set, exclusive of modules 201, 202 identified in the logic stored in complete software data 170.

Hence, returning again to FIG. 4, at step 412 it is determined if installation data for adding the first subset to software bundle 101 is stored locally, for example in memory 127 at computing device 103. In some of these embodiments, the installation data can be stored in association with application 131. For example, when application 131 is installed and/or updated installation data for some modules 202 can be stored in memory 127, the installation data similar to installation data stored in software bundle data 109 at server 108.

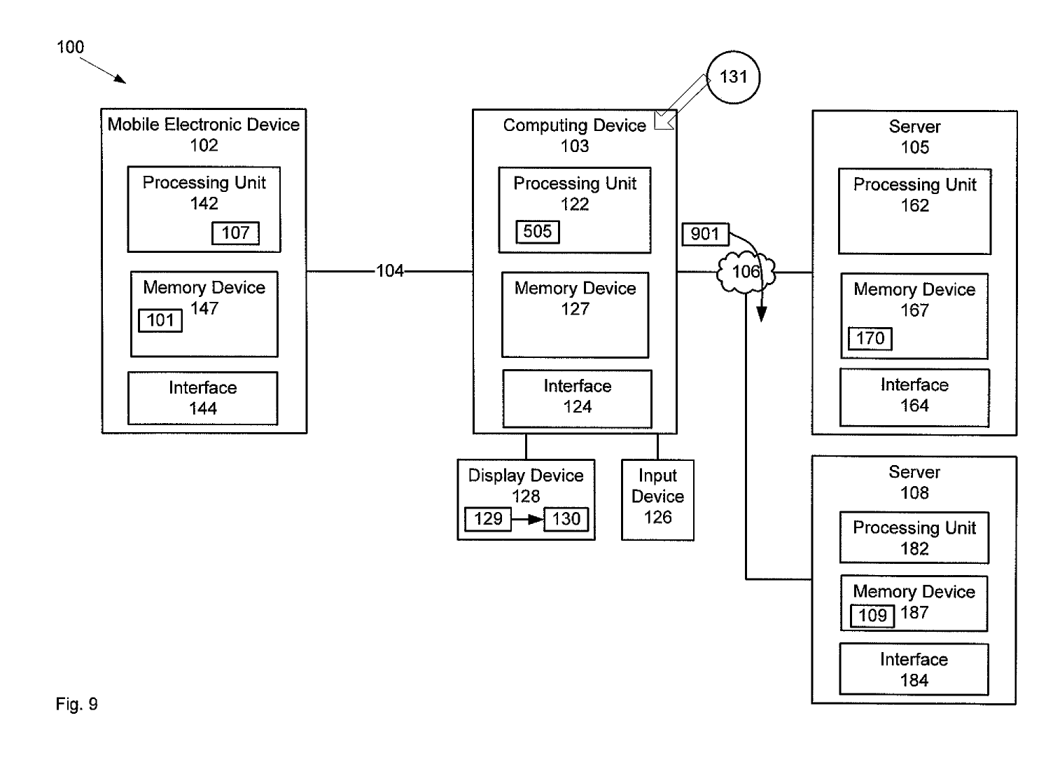

If the installation data is stored locally, step 417 occurs, described below. If not, however, at step 413, installation data for adding the first subset to software bundle 101 is then requested from server 108, via communication network 106. For example, a request 901 is transmitted from computing device 103 to server 108, via communication network 106 (e.g. as depicted in FIG. 9, substantially similar to FIG. 1 with like elements having like numbers). Request 901 comprises data for identifying the first subset, for example associated identifiers 203 (e.g. identifier 203h identifying module 202h).

Server 108 responds by retrieving the installation data, associated with the first subset, from the appropriate module 202 (e.g. module 202h), and transmitting the installation data to computing device 103, where it is received at step 415. Then, at step 417, software bundle 101 is updated by: causing the installation data to be installed on mobile electronic device 102 via local connection 104; and causing the second subset to be removed from mobile electronic device 102. Causing the installation data to be installed on mobile electronic device 102 can comprise computing device 103 transmitting the installation data to mobile electronic device 102 via local connection 104 where it is processed for installation by mobile electronic device 102. In some embodiments, an install command is transmitted along with the installation data. Similarly, causing the second subset to be removed from mobile electronic device 102 can comprise transmitting an uninstall command to the mobile electronic device 102, along with respective identifiers 203 associated with modules 201 in the second set (and/or respective identifiers 301).

In contrast, in the prior art, a full system upgrade would occur in which memory device 147, of mobile communication device 102, would be wiped clean/erased, and only modules 202 to be added and/or upgraded would be installed.

In some embodiments, during or after updating software bundle 101, new device configuration data is generated (and/or device configuration data 107 is updated), and optionally stored in memory device 147, to reflect the updates to software bundle 101.

It is understood that in embodiments where software bundle data 170 and complete software bundle data 109 are stored at server 105, the installation data is alternatively requested from server 105 via communication network 106.

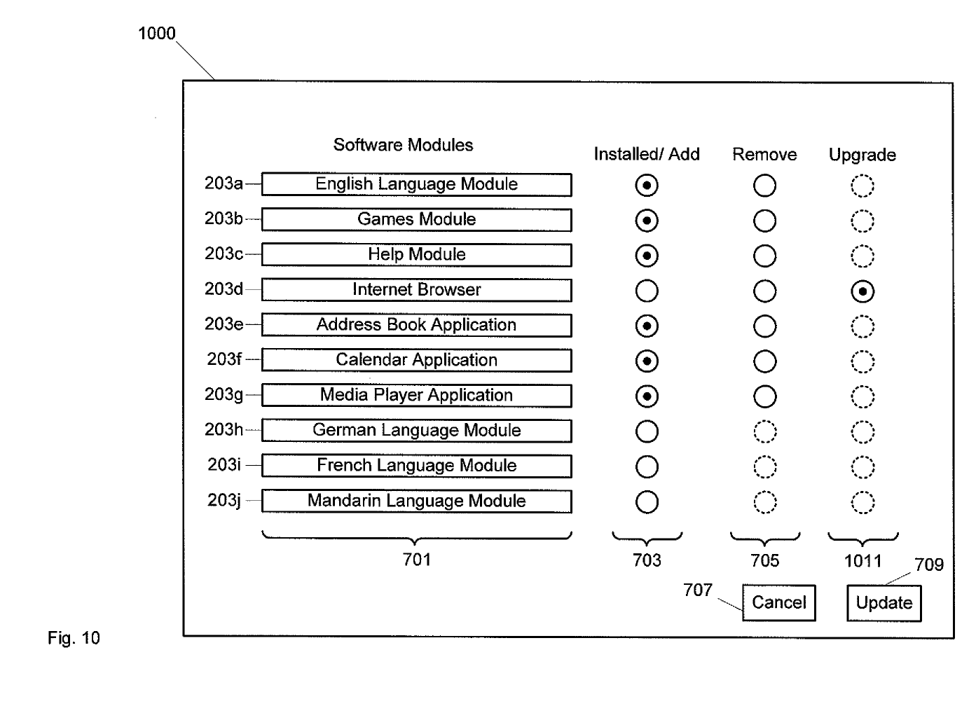

It is further understood that, in some embodiments, only certain modules 201, 202 can be added, deleted and/or upgraded. For example, in some embodiments, some modules 201, 202 can be “core” modules and are part of the operating system of mobile communication device 102, while other modules 201, 202 are optional modules (e.g. games modules, help modules, 3^{rd} party applications, 3^{rd} party browsers, etc.). In these embodiments, only the optional modules can be added, deleted and/or upgraded. Such logic can be effected by controlling representation 700 to provide identifiers of only the modules which can be added, deleted and/or upgraded (e.g. see FIG. 10, described below).

Attention is now directed to FIG. 10, which depicts non-limiting embodiments of a representation 1000. In some embodiments, representation 130 can comprise representation 1000. Representation 1000 is similar to representation 700 with like elements having like numbers. However, in these embodiments, representation 1000 comprises indicators 1011 provided adjacent each item in list 701, indicative of whether a respective module 201 in software bundle 101 can be upgraded. For example, rather than a module 201 being removed and/or a new module 202 being installed/added, representation 1000 allows for a further option: that of a module 201 being upgraded, for example if a newer version of module 201 is available, including but not limited to patches, new submodules, new functionality to an application, and the like. Hence, in these embodiments, further modules 202 are stored at server 108 corresponding to respective available upgrades of modules 201. Hence, server 108 can store both an upgrade module 202 for a given module 201 as well as an installation module 202 for the given module 201. Both can be identified via the same identifier 301 and/or 203, however an additional indicator can be provided at server 105 (e.g. within software bundle data 170) to indicate that both an installation module 202 and an upgrade module 202 are available. For example, if the installation module 202 has not yet been installed (e.g. there is no corresponding module 201 installed in software bundle 101) then, in some embodiments, representation 1000 can be controlled to provide the option of installing it, via indicators 703. However, if there is a corresponding module 301, then representation 1000 can be controlled to provide an option of removing the corresponding module 301, via indicators 705 and/or upgrading the corresponding module 301, via indicators 1011. If the upgrade option is chosen, then upgrade data stored in the upgrade module 202 is retrieved by computing device 103, and installed at mobile electronic device 102. In some embodiments, only the upgrade option can be available. Furthermore, in other embodiments, as described above, only optional modules 201, 202 are available to be added, deleted and/or upgraded.

It is further understood that complete software bundle data 109 can itself be updated, for example as more modules 202, patches, etc. become available. Such updates can be implemented automatically via communications with other servers, and the like, where such updates are being stored, and/or by an administrator of system 100 and/or server 108. In any event, as such updates occur, software bundle data 170 is also updated to reflect the changes to complete software bundle 109, automatically via communications between server 108 and server 105 (e.g. controlled by processing unit 162 and 182) and/or by a suitable administrator.

Hence, methods, systems and apparatus are provided for updating a software bundle at a mobile electronic device using a local connection, which reduces bandwidth used on expensive wireless networks, for example those operated by a carrier network operator. Furthermore, as software modules associated with a software bundle can be added, removed and/or upgraded, the software bundle does not need to be uninstalled and then reinstalled with new options, hence saving on system resources at the mobile electronic device on which it is located, as well as on bandwidth in downloading the data for effecting the reinstallation.

Those skilled in the art will appreciate that in some embodiments, the functionality of mobile electronic device 102, computing device 103 and servers 105, 108 can be implemented using pre-programmed hardware or firmware elements (e.g., application specific integrated circuits (ASICs), electrically erasable programmable read-only memories (EEPROMs), etc.), or other related components. In other embodiments, the functionality of mobile electronic device 102, computing device 103 and servers 105, 108 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Alternatively, the computer-readable program code could be stored remotely but transmittable to these components via a modem or other interface device connected to a network (including, without limitation, the Internet) over a transmission medium. The transmission medium can be either a non-wireless medium (e.g., optical and/or digital and/or analog communications lines) or a wireless medium (e.g., microwave, infrared, free-space optical or other transmission schemes) or a combination thereof.

A portion of the disclosure of this patent document contains material which is subject to copyright protection. The copyright owner has no objection to the facsimile reproduction by any one the patent document or patent disclosure, as it appears in the

Patent and Trademark Office patent file or records, but otherwise reserves all copyrights whatsoever.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

What is claimed is:

1. A method for updating a software bundle installed on a mobile electronic device, via a computing device enabled for communication with said mobile electronic device via a local connection, and further enabled for communication with at least one server storing software bundle data, via a communication network, said method comprising:
receiving device configuration data, at said computing device, from said mobile electronic device via said local connection;
transmitting at least a portion of said device configuration data from said computing device to said at least one server via said communication network;
comparing said at least a portion to said software bundle data to identify software modules for updating said software bundle;
determining a first subset of said software modules to be added to said software bundle and a second subset of said software modules to be removed from said software bundle;
determining if installation data for adding said first subset to said software bundle is stored at said computing device and, if not, requesting said installation data from said at least one server via said communication network; and
updating said software bundle by:
causing said installation data to be installed on said mobile electronic device via said local connection once said installation data is received from said at least one server; and
causing said second subset to be removed from said mobile electronic device.

2. The method of claim 1, further comprising:
determining a third subset of said software modules to be upgraded in said software bundle;
requesting upgrade data for upgrading said third subset in said software bundle, from said at least one server via said communication network; and
further updating said software bundle by causing said upgrade data to be installed on said mobile electronic device via said local connection once said upgrade data is received from said at least one server.

3. The method of claim 1, further comprising receiving said software bundle data at said computing device such that said comparing occurs at said computing device.

4. The method of claim 1, wherein said comparing occurs at said server, said method further comprising receiving, at said computing device, data identifying said software modules for updating, from said server.

5. The method of claim 1, wherein said determining said first subset and said second subset comprises:
controlling a display device associated with said computing device to provide a representation of a list of said software modules for updating said software bundle; and, in response,
receiving input data from an input device associated with said computing device, said input data indicative of said first subset and said second subset, each respectively chosen from said list.

6. The method of claim 1, wherein said device configuration data comprises at least an identifier for identifying said software bundle, a carrier identifier for identifying a carrier network operator, a list of installed application modules associated with said software bundle and a list of installed language modules associated with said software module.

7. The method of claim 1, wherein said software modules for updating said software bundle comprises at least one of application modules and language modules for installation in said software bundle.

8. The method of claim 1, wherein said local connection comprises at least one of a wired connection, a wireless connection, a cabled connection, a USB connection, a WiFi connection, a Bluetooth connection, and a near field communication (NFC) connection.

9. The method of claim 1, wherein said at least a portion is transmitted to a first server for storing said software bundle data and said installation data is requested from a second server for storing said installation data.

10. A computing device for updating a software bundle installed on a mobile electronic device, comprising:
a processing unit interconnected with a memory device and a communication interface enabled for communication with said mobile electronic device via a local connection, and communication interface further enabled for communication with at least one server storing software bundle data via a communication network, said processing unit enabled to:
receive device configuration data from said mobile electronic device via said local connection;
transmit at least a portion of said device configuration data to said at least one server via said communication network such that said at least a portion is compared to said software bundle data to identify software modules for updating said software bundle;
determine a first subset of said software modules to be added to said software bundle and a second subset of said software modules to be removed from said software bundle;
determine if installation data for adding said first subset to said software bundle is stored at said memory device and, if not, request said installation data from said at least one server via said communication network; and
update said software bundle by:
causing said installation data to be installed on said mobile electronic device via said local connection once said installation data is received from said at least one server; and
causing said second subset to be removed from said mobile electronic device.

11. The computing device of claim 10, wherein said processing unit is further enabled to:
determine a third subset of said software modules to be upgraded in said software bundle;
request upgrade data for upgrading said third subset in said software bundle, from said at least one server via said communication network; and
further update said software bundle by causing said upgrade data to be installed on said mobile electronic device via said local connection once said upgrade data is received from said at least one server.

12. The computing device of claim 10, wherein said processing unit is further enabled to receive said software bundle data at said computing device such that said at least a portion is compared to said software bundle data occurs at said computing device.

13. The computing device of claim 10, wherein said at least a portion is compared to said software bundle data at said server and said processing unit is further enabled to receive data identifying said software modules for updating, from said server.

14. The computing device of claim 10, wherein said processing unit is further enabled to determine said first subset and said second subset by:
controlling a display device associated with said computing device to provide a representation of a list of said software modules for updating said software bundle; and, in response,
receiving input data from an input device associated with said computing device, said input data indicative of said first subset and said second subset, each respectively chosen from said list.

15. The computing device of claim 10, wherein said device configuration data comprises at least an identifier for identifying said software bundle, a carrier identifier for identifying a carrier network operator, a list of installed application modules associated with said software bundle and a list of installed language modules associated with said software module.

16. The computing device of claim 10, wherein said software modules for updating said software bundle comprises at least one of application modules and language modules for installation in said software bundle.

17. The computing device of claim 10, wherein said local connection comprises at least one of a wired connection, a wireless connection, a cabled connection, a USB connection, a WiFi connection, a Bluetooth connection, and a near field communication (NFC) connection.

18. The computing device of claim 10, wherein said at least a portion is transmitted to a first server for storing said software bundle data and said installation data is requested from a second server for storing said installation data.

19. A system for updating a software bundle, comprising:
a mobile electronic device, said software bundle installed thereon;
at least one server storing software bundle data; and
a computing device enabled for communication with said mobile electronic device via a local connection, and further enabled for communication with at least one server storing software bundle data, via a communication network, said computing device enabled to:
receive device configuration data from said mobile electronic device via said local connection;
transmit at least a portion of said device configuration data to said at least one server via said communication network such that said at least a portion is compared to said software bundle data to identify software modules for updating said software bundle;
determine a first subset of said software modules to be added to said software bundle and a second subset of said software modules to be removed from said software bundle;
determine if installation data for adding said first subset to said software bundle is stored at said computing device and, if not, request said installation data from said at least one server via said communication network; and
update said software bundle by:
causing said installation data to be installed on said mobile electronic device via said local connection once said installation data is received from said at least one server; and
causing said second subset to be removed from said mobile electronic device.

20. A computer program product, comprising a computer usable medium having a computer readable program code adapted to be executed to implement a method for updating a software bundle installed on a mobile electronic device, via a computing device enabled for communication with said mobile electronic device via a local connection, and further enabled for communication with at least one server storing software bundle data, via a communication network, said method comprising:
receiving device configuration data, at said computing device, from said mobile electronic device via said local connection;
transmitting at least a portion of said device configuration data from said computing device to said at least one server via said communication network;
comparing said at least a portion to said software bundle data to identify software modules for updating said software bundle;
determining a first subset of said software modules to be added to said software bundle and a second subset of said software modules to be removed from said software bundle;
determining if installation data for adding said first subset to said software bundle is stored at said computing device and, if not, requesting said installation data from said at least one server via said communication network; and
updating said software bundle by:
causing said installation data to be installed on said mobile electronic device via said local connection once said installation data is received from said at least one server; and
causing said second subset to be removed from said mobile electronic device.
